(19) United States
(12) Patent Application Publication
(10) Pub. No.: US 2010/0020236 A1
(43) Pub. Date: Jan. 28, 2010

(54) IMAGE DISPLAY APPARATUS AND METHOD

(75) Inventor: Chi-chin Lien, Taipei City (TW)

Correspondence Address: KIRTON AND MCCONKIE, 60 EAST SOUTH TEMPLE,, SUITE 1800, SALT LAKE CITY, UT, 84111, US

(73) Assignee: MEDIATEK INC., Hsin-Chu (TW)

(21) Appl. No.: 12/181,021

(22) Filed: Jul. 28, 2008

(51) Int. Cl. H04N 5/46

(52) U.S. Cl. 348/555

(57) ABSTRACT

An image display apparatus and method are disclosed. In the present invention, an input image frame having a first solution is scaled by a scaling module so that a scaled image frame having a second dimension is generated. The scaled image frame is processed by a display device supporting the second dimension. The display device generates display signals corresponding to the scaled image frame and transmits the display signal to a display interface. Accordingly, the display interface can display an output image frame in the second dimension based on the display signals.

### TECHNICAL FIELD OF THE INVENTION

The present invention relates to image display, more particularly, to an apparatus and method for displaying image frames of various formats with a predetermined dimension.

### BACKGROUND OF THE INVENTION

As image displaying techniques are rapidly developed, more and more image sources such as HDTV program contents and digital photographs are generated in HD (high definition) formats or higher formats with great dimensions. Currently, a lot of display equipments such as TV sets or DVD player existing in families only have the ability to support SD (standard definition) formats but not HD formats. To display image frames of different resolutions and dimensions on the display interface with format limits becomes an important issue.

Taking TV display as an example, image frames of resolution formats 480i (dimension: 720×480), 576i (dimension: 720×576), 480p (dimension: 720×480), and 576p (dimension: 720×576) are classified as SD formats. Images frames of resolution formats 720p (dimension: 1280×720) and 1080i (dimension: 1920×1080) and 1080p (dimension: 1920×1080) are classified as HD formats, in which 1080p is referred to “full HD”. The character “i” indicates “interlace”, means that a frame is divided into two fields to be output at two time points. The character “p” indicates “progressive”, means that a frame is scanned line by line and output at a time. As known, the progressive display scheme needs a bandwidth which is almost double as compared to that required by the interface scheme. The dimension of an image frame of 200 million pixels is about the same as full HD.

For an image output device such as a digital camera, the dimension of the output image frame is of the order of millions of pixels, or even higher. In addition, the image frame which meets the standard of blu-ray disc (BD) or HDTV is at the grade of HD format. As mentioned above, some existing display equipments have no ability to support HD formats. Accordingly, it is necessary to display high-resolution images of various formats on the display interface (e.g. a TV set) with a selected resolution such as an SD format.

FIG. 1 shows an image display apparatus of prior art. The image display apparatus supports SD format. The image display apparatus includes a resizer 1 for down-scaling an input HD image frame (e.g. an image frame with dimension 1920×1080 or 1280×720) into an SD format (e.g. dimension 720×480 or 720×576). The down-scaled image frame is then stored in a frame buffer 3, which can be implemented by an SDRAM in practice. The image frame is transmitted to an SD display device 5. The SD display device 5 supports SD format(s) such as dimension 720×480 or 720×576. The SD display device 5 is used to convert the image frame into display signals. If the input image frame is an SD image frame of dimension 720×480 or 720×576, for example, rather than the HD image frame, it can bypass the resizer 1 and frame buffer 3 and can be directly fed to the SD display device 5 to be processed. The image display apparatus includes a display interface 9. In a case that the display interface 9 is capable of supporting an SD format of 2880×480 or 2880×576, an up-sampling device 7 is used to execute an up-sampling operation to the display signals from the SD display device 5 so as to over-sample the image frame in horizontal direction, and thereby an output image frame of dimension 2880×480 or 2880×576 can be displayed on the display interface 9. In such an image display apparatus, the input HD image frame is down-scaled into the SD format by the rezier 1 and then is up-sampling by the up-sampling device 7 to the dimension that the display interface 9 is to display the image frame. Through the operations of down-scaling and up-sampling, some data of the input image may be lost and results in distortion of the image frame. The present invention provides an effective and efficient solution to such a problem.

### SUMMARY OF THE INVENTION

The present invention is to provide an image display apparatus, which is used to display image frames of various dimensions in a specific dimension with a simple and direct scheme. In addition, the present invention is to provide an image display method executed in the image display apparatus so as to simply and directly display image frames of various dimension in a specific dimension. By using the present invention to display image frames of various dimensions in the specific dimension, hardware structure is simplified. Furthermore, lost of image data is decreased so that distortion is reduced.

In accordance with the present invention, the image display apparatus comprises a scaling module for performing an adjustment on an input image frame, said scaling module receiving the input image frame having a first dimension, scaling said input image to generate a scaled image frame having a second dimension; a display device being capable of supporting the second dimension, said display device receiving said scaled image frame and processing the scaled image frame to generate corresponding display signals; and a display interface receiving the display signals corresponding to the scaled image frame from the display device and displaying an output image in the second dimension based on the display signals received from said display device. The scaling module can perform the scaling operation to the image frame in horizontal and vertical directions at a time. Alternatively, the scaling module scales the image frame firstly in one of the two direction, and then scales the image frame in the other direction.

In accordance with the present invention, the image display method comprises performing an adjustment on an input image frame having a first dimension to scale the input image frame, so as to generate a scaled image frame having a second dimension; receiving said scaled image frame having the second dimension and executing image process to the scaled image frame having the second dimension so as to generate display signals corresponding to said scaled image frame having the second dimension; receiving the display signals corresponding to the scaled image frame having the second dimension to generate an output image frame having the second dimension based on the display signals; and displaying said output image frame having the second dimension. The image frame is scaled in horizontal and vertical directions at a time. Alternatively, the image frame is firstly scaled in one direction and then scaled in the other direction.

### BRIEF DESCRIPTION OF THE DRAWINGS

The present invention will be further described in details in conjunction with the accompanying drawings.

FIG. 1. is a block diagram schematically showing an image display apparatus of prior art;

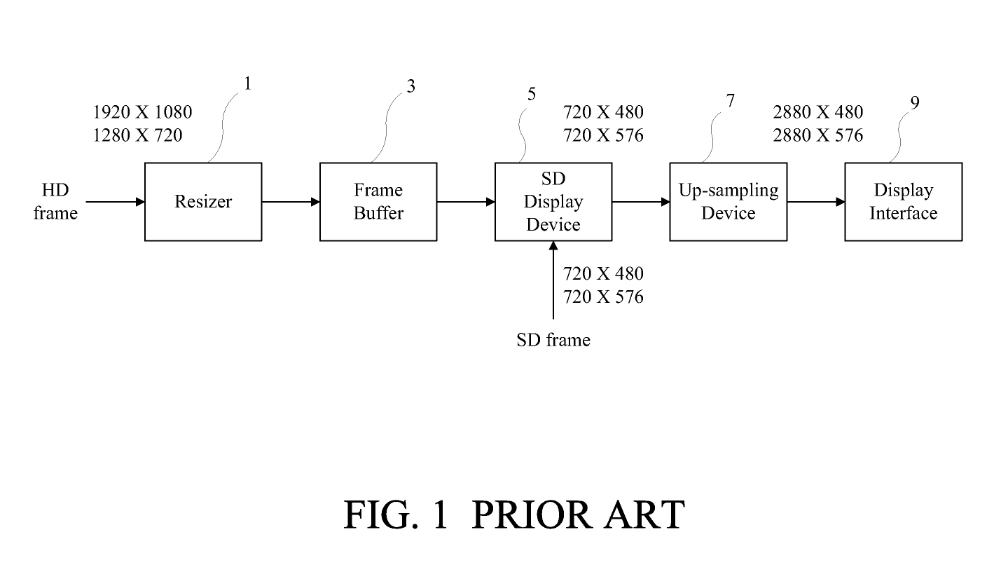

FIG. 2. is a block diagram schematically and generally illustrating an image display apparatus in accordance with the present invention; and

FIG. 3 schematically shows an embodiment of a scaling module used in the image display apparatus in accordance with the present invention.

### DETAILED DESCRIPTION OF THE INVENTION

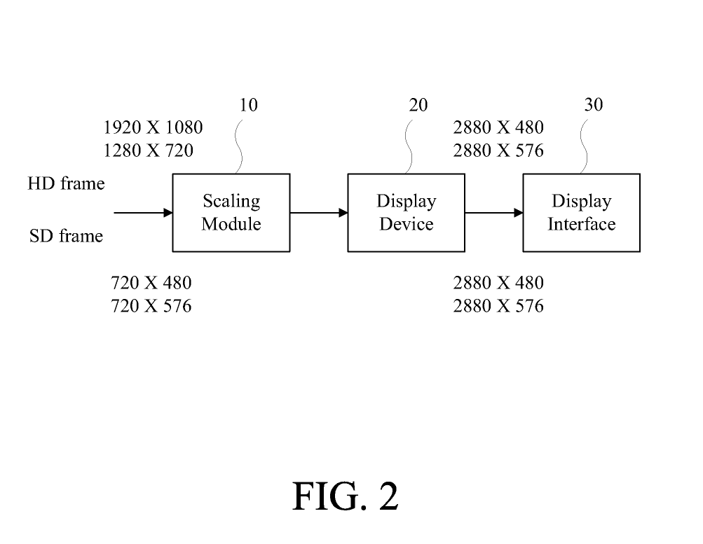

FIG. 2 is an illustration schematically showing an image display apparatus in accordance with the present invention. The image display apparatus of the present invention includes a scaling module 10, a display device 20 and a display interface 30, the details thereof will be further described as follows.

Assumed that the display interface 30 is set to display an image frame in a dimension of 2880×480 or 2880×576, then the display device 20 of the present invention should be able to support such a dimension. That is, the display device 20 converts an image frame of such a dimension (2880×480 or 2880×576) into display signals. The display signals are transmitted to the display interface 30, which can be a TV set, for example, so that the display interface 30 can display the image frame in the format of dimension 2880×480 or 2880×576. In other words, the display device 20 matches the display interface 30 in image frame dimension.

As described above, the image display apparatus in accordance with the present invention has the scaling module 10. The scaling module 10 is used for performing an adjustment on an input image frame to scale the input image frame, thereby adjusting the dimension of the input image frame into the dimension that the display interface 30 is to display the image frame. In this example, the scaling module 10 scales the input image frame into the dimension 2880×480 or 2880×576 no matter the input image frame is an HD image frame or an SD image frame.

If the input image frame is an HD image frame of dimension 1920×1080 or 1280×720, the image frame is scaled by the scaling module 10 to generate a scaled image frame, and the dimension of scaled image frame is 2880×480 or 2880×576. The scaled image frame is transmitted to the display device 20 directly. The display device 20 receives the scaled image frame and generates corresponding display signals. The display signals are transmitted to the display interface 30. Accordingly, the display interface 30 displays an output image frame based on the display signals in the format 2880×480 or 2880×576.

If the input image frame is an SD image frame of dimension 720×480 or 720×576, the image frame is sent to the scaling module 10. The scaling module 10 up-scales (i.e. over-samples) the input image frame to generate a scaled image frame, and the dimension of scaled image frame is 2880×480 or 2880×576. The scaled image frame is transmitted to the display device 20 directly. It is noted that no frame buffer is used herein. The display device 20 receives the scaled image frame and generates corresponding display signals. The display signals are transmitted to the display interface 30. Accordingly, the display interface 30 displays an output image frame based on the display signals in the format 2880×480 or 2880×576.

As described above, no matter the input image frame is in HD or SD format, the image display apparatus in accordance with the present invention directly scales the input image frame into the scaled image frame having the output dimension required by the display interface 30. In comparison with the prior art, the structure of the image display apparatus in accordance with the present invention is simplified. In addition, for HD image frames, distortion can be reduced since it does not need to down-scale and then up-sample the HD image frame. Instead, one-time scaling is used to directly scales the image frame into the required dimension. Therefore, the lost degree of data is lowered, so that distortion is accordingly reduced.

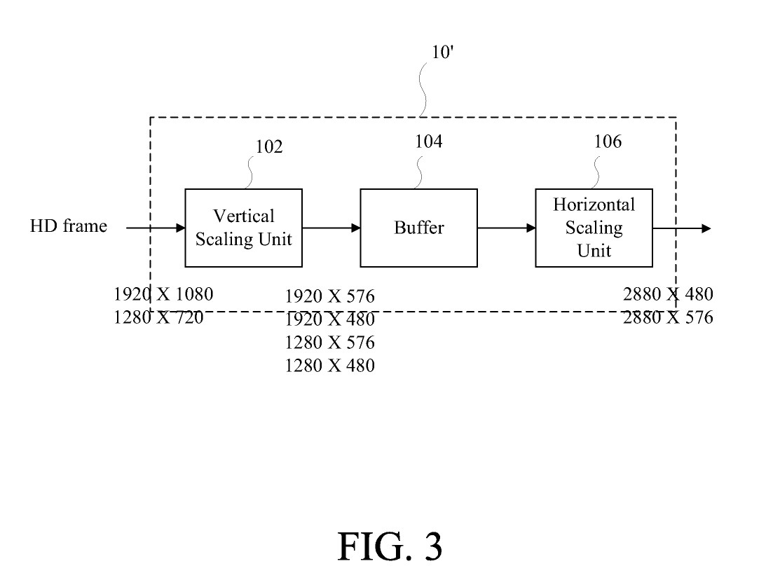

The scaling module 10 can execute scaling operation by scaling the image frame in horizontal and vertical directions. The scaling operation can be implemented by zooming in and out the image frame. However, the scaling module can also execute scaling operation by two-step scaling. FIG. 3 shows an example of a two-step scaling module 10′. The scaling module 10′ scales an image frame in two steps. That is, the scaling module 10′ scales the image frame in one direction and then scales the image frame in the other direction. As shown, in this example, the scaling module 10′ has a vertical scaling unit 102, and buffer 104 and a horizontal scaling unit 106. It is noted that the relative positions of the vertical and horizontal scaling units 102, 104 can be exchanged. An HD image frame of dimension 1920×1080 or 1280×720 is input, for example. The vertical scaling unit 102 scales the image frame in vertical direction to generate a first scaled image frame of dimension 1920×576/1920×480 or 1280×576/1280×480. That is, the vertical dimension of the image frame is down-scaled to 480 or 576, but the horizontal dimension of the image frame maintains the same as the original size. The first scaled image frame is stored in the buffer 104. Then the first scaled image frame from the buffer 104 is fed to the horizontal scaling unit 104. The horizontal scaling unit 104 scales the first scaled image frame in horizontal direction to generate a second scaled image frame. The second scaled image frame has the dimension of 2880×480 or 2880×576. That is, the horizontal dimension of the image frame is up-scaled to 2880, but the vertical dimension maintains the same as the size of the first scaled image frame. By doing so, cost is reduced since single-directional scaling hardware is much cheaper than two-directional scaling hardware. It can be known that also the scaling is done by two steps in two directions, respectively, the problem of distortion can still be avoided, since data of the image frame in vertical or horizontal direction is not over down-scaled and then up-sampled.

While the preferred embodiment of the present invention has been illustrated and described in details, various modifications and alterations can be made by persons skilled in this art. The embodiment of the present invention is therefore described in an illustrative but not in a restrictive sense. It is intended that the present invention should not be limited to the particular forms as illustrated, and that all modifications and alterations which maintain the spirit and realm of the present invention are within the scope as defined in the appended claims.

What is claimed is:

1. An image display apparatus for displaying image frames of various dimensions in a predetermined output dimension, said image display apparatus comprising:
a scaling module for performing an adjustment on an input image frame, wherein the scaling module receives the input image frame having a first dimension and scales the input image to generate a scaled image frame having a second dimension; and
a display interface receiving display signals corresponding to the scaled image frame from the scaling module and displaying an output image in the predetermined output dimension based on the display signals,
wherein the first dimension is directly over-sampled to generate the second dimension the same as the predetermined output dimension if the first dimension is less than the predetermined output dimension, and the first dimension is processed by a one-time scale if the first dimension is larger than the predetermined output dimension.

2. The apparatus of claim 1, wherein the one-time scale is to scale the input image having the first dimension in horizontal and vertical directions substantially at the same time.

3. The apparatus of claim 1, wherein the one-time scale is performed without two stages of scaling process.

4. The apparatus of claim 1, wherein the one time scale is performed without downscaling the first dimension and over-sampling the downscaled first dimension.

5. The apparatus of claim 1, wherein the scaling module scales the input image having the first dimension in a first direction to obtain an intermediate image having a third dimension and then scales the intermediate image having the third dimension in a second direction to generate the scaled image having the second dimension.

6. The apparatus of claim 5, wherein the scaling module comprises a resizer for scaling the input image having the first dimension in a first direction to obtain the intermediate image having the third dimension, a buffer for buffering the intermediate image and a scaler for scaling the intermediate image having the third dimension in the second direction to generate the scaled image having the second dimension.

7. The apparatus of claim 5, wherein the first direction is vertical direction.

8. The apparatus of claim 5, wherein the second direction is horizontal direction.

9. An image display method for displaying image frames of various dimensions in a predetermined output dimension, the image display method comprising:
receiving an input image frame having a first dimension;
performing an adjustment on an input image frame to scale the input image and generate a scaled image frame having a second dimension;
receiving display signals corresponding to the scaled image frame; and
displaying an output image in the predetermined output dimension based on the display signals,
wherein the first dimension is directly over-sampled to generate the second dimension the same as the predetermined output dimension if the first dimension is less than the predetermined output dimension, and the first dimension is processed by a one-time scale if the first dimension is larger than the predetermined output dimension.

10. The method of claim 9, wherein the input image frame having the first dimension is scaled in horizontal and vertical directions substantially at the same time.

11. The method of claim 9, wherein the step of performing the adjustment comprises scaling the input image frame having the first dimension in a first direction to obtain an intermediate image frame having a third dimension and then scaling the intermediate image frame having the third dimension in a second direction to generate the scaled image frame having the second dimension.

12. The method of claim 11, further comprising buffering the intermediate image frame before scaling the intermediate image frame having the third dimension in the second direction to generate the scaled image frame with the second dimension.

13. The method of claim 11, wherein the first direction is vertical direction.

14. The method of claim 11, wherein the second direction is horizontal direction.

15. The method of claim 9, wherein the one-time scale is performed without two stages of scaling process.

16. The method of claim 9, wherein the one time scale is performed without downscaling the first dimension and over-sampling the downscaled first dimension.
